(19) United States
(12) Patent Application Publication
(10) Pub. No.: US 2022/0351097 A1
(43) Pub. Date: Nov. 3, 2022

(54) METHOD AND APPARATUS FOR GENERATING SAFETY INFORMATION BY USING DAILY OPERATION REPORT

(71) Applicant: Kyeongok YANG, Seoul (KR)

(72) Inventor: Kyeongok YANG, Seoul (KR)

(21) Appl. No.: 17/602,456

(22) PCT Filed: Apr. 10, 2019
(86) PCT No.: PCT/KR2019/004257

§ 371 Date: Jun. 21, 2022

(51) Int. Cl. G06Q 10/06

(52) U.S. Cl. CPC G06Q 10/0635

(57) ABSTRACT

A method includes: a first step of setting a safety standard by stipulating a safety item for each activity and determining a relationship with parallel, preceding, and subsequent activities; a second step of preparing a daily job-site work report of a partner company while construction is processing by each partner company; a third step of analyzing contents of the daily job-site work report and generating activity performance information by a control unit; a fourth step of evaluating the risk for each activity by the control unit by determining whether activity information of the second or third step exceeds the safety standard of the first step and; a fifth step of determining that there is a risk when the safety standard is exceeded as a result of comparing the steps.

### TECHNICAL FIELD

The present invention is provided to prevent safety disasters occurring during construction on construction and industrial construction sites, and more specifically, relates to taking preventive measures in advance by analyzing risks by a control unit by using information of a lot of construction process on daily job-site work reports daily prepared by a number of partner companies of temporal installation, civil engineering, construction, electricity, and equipment, in a case where a parallel activity and a preceding activity are not completed or in a case where a subsequent activity does not follow the preceding activity for all activities on the site.

### BACKGROUND

For industrial accidents, the number of fatalities per 100,000 persons was 3.0 in OECD and 7.0 in Korea, which is twice that of the OECD (reported on Aug. 28, 2017 in the daily newspaper of Jungang Ilbo in Korea).

According to an industrial accident occurrence status in 2016 announced by the Ministry of Employment and Labor in Korea, the total number of industrial accidents was 90,656, which means that more than 10 disaster victims occur per hour. Among them, the number of construction disaster victims is accounted for 29.3% of those in all industries. The total number of fatal disaster victims is 1,777, with more than one fatality occurring every 5 hours, and the number of fatalities in construction is 31.2% of those in all industries.

In 2016, the number of fatal disaster victims in all industries was 969, among them, the number of fatal disaster victims in the construction industry was 499, that is, 51.5% of all industries (reported on May 25, 2017 in the daily newspaper of Construction Economy in Korea).

With the development of construction technology, the construction of high-rise buildings and high-rise apartment buildings that rise high into the sky has increased, and the construction of digging deep underground is increasing along with large shopping malls and large-scale factory complexes spreading horizontally.

As a result, up to thousands of workers per day are distributed vertically and horizontally in many spaces, and the activities of dozens or hundreds of temporal installation, construction, electricity, and equipment are complicatedly processed with each other, so that the activity management of the construction company is becoming difficult and there is a limit to expanding the number of safety managers.

While safety objects of to be managed becomes vast and complex, the traditional method of management by manpower is maintained.

For example, in a case where the manager lacks construction experience and in a case where there is a safety problem in a specific space but the problem is not recognized, safety management centered on manpower means that misunderstanding occurs, safety facilities are dismantled or moved without permission, communication between activity types of the preceding activity and the subsequent activity is not successful, the worker enters a prohibited area erroneously, the worker does not properly equip with safety facilities, and the like.

The following is a contribution from a safety expert.

As any safety-related expert knows, there is a principle of cause connection among the four principles of disasters. All disasters have a cause. The most unfortunate of all construction accidents is that no matter how much the injured person complies with the safety activity procedures, the accident can occur if the wrong activity conditions are prepared in the preceding process.

Such examples occur in most cases of construction accidents (reported on May 25, 2017 in the daily newspaper of Construction Economy in Korea).

It is determined that the conventional safety management method as described above has a part that cannot manage vast and complex activities or safety facilities, equipment, and workers based on limited manpower and experience.

As documents related to safety management, there are a risk evaluation report, a hazard prevention plan report, a night activity permit report, an activity report, and the like.

First, in the case of the risk evaluation, the process is as follows.

In the early stage of construction, when preparing the hazard prevention plan report, a safety management plan report, or a construction plan report, an initial risk evaluation is carried out, the risk evaluation report is prepared in consideration of the on-site situation before the relevant activity, and the activity from material import to construction material export is divided into detailed units, and a schedule bar chart is prepared.

If a unit activity is classified, risk factors (human factors, mechanical factors, electrical factors, material factors, activity characteristic factors, activity environment factors, and the like) are identified for the activity. Safety measures that can be taken on-site for identified risk factors are established and risks review by a preparer, a construction manager, and a safety manager are determined.

On the other hand, the risk evaluation report is important and evaluates a part of the overall activities focusing on the activity with a high risk level, and the evaluation contents are being prepared according to the individual capabilities of the partner company.

Therefore, there are some activities that have not been evaluated because the risk evaluation does not cover the entire activities. In particular, since many activities are carried out simultaneously during the finishing construction period such as interior, it takes a lot of time and effort to prepare the risk evaluation and an evaluation meeting, so only a major activity has to be selected and managed.

On the other hand, the daily job-site work report is a construction plan and record prepared in a text format by dozens or hundreds of partner companies, such as temporary installation, civil engineering, construction, electricity, and equipment, participating in the construction. The daily job-site work report includes the activity performed the previous day and contents of the activity to be done today, and the number of working persons and equipment is additionally described therein.

The purpose of preparing the daily job-site work report is to simply know which partner company is doing where and what.

The daily job-site work report has an advantage that it takes less time and effort to prepare because it copies the text sentence describing the previous day's activity and pastes it into today's activity, and is prepared by the partner company by using on-site PMIS or word processor Excel program.

On the other hand, the daily job-site work report has a disadvantage in that it is difficult to comprehensively grasp the overall progress as the contents are distributed in pieces by date like a tile mosaic on the wall.

In addition, since each partner company prepares the daily job-site work report by one page, the contents thereof are difficult to see the whole as it becomes more than tens of pages during the construction finishing and interior construction period.

The daily job-site work report is not prepared for the purpose of safety management because each partner company briefly describes the contents of where, what, and how many persons work today.

### SUMMARY OF INVENTION

### Technical Problem

In the prior art, the risk was mainly evaluated based on the main activity, but the present invention introduces a concept of a total investigation that evaluates the risk for all activities on the site. This is because safety disasters occur not only in the major activity but also in the minor activity.

In the prior art, the cause of a disaster was identified focusing on visually visible problems in a specific space, but in the present invention, in addition to the conventional analysis method, a causal relationship between the preceding activity and the subsequent activity affecting the activity is comprehensively analyzed in a time series.

The risk can be determined quantitatively and immediately from the objective and systematic safety standards verified by many experts in advance from the safety management centered on individual experiences and abilities.

### Solution to Problem

In order to solve the above-described technical problems, the present invention evaluates the risk of equipment, a temporary material, or the like necessary for a partner company to perform the activity.

What other dangerous parallel activities are in the same workspace is defined.

By analyzing an influence of the preceding activity and an influence of the subsequent activity, what state of the preceding activity and the subsequent activity should be is comprehensively analyzed in time series to ensure that the current activity is safe.

In order to determine whether a specific activity is dangerous, risk evaluation standards are established through objective data standards, laws, regulations, cases, expert opinions, or the like.

The risk evaluation standards include standards (height, strength, size, installation time, retention period, and dismantling time) for safety facilities, standards (activity Conditions for construction, temporal installation, electricity, equipment such as temperature, humidity, wind, toxic gas, lighting, electric shock, and pressure) for activity conditions, a schedule difference (condition that the preceding activity must be completed) of the preceding activity, and a schedule difference (condition that the subsequent activity must follow) with the subsequent activity.

These data are classified by construction type, operation type, and activity type, and made into a DB.

A method of collecting activity information utilizes daily job-site work reports which have been conventionally done without additional effort or system manpower.

Since the daily job-site work reports are daily records of activity contents by all partner companies, the daily job-site work reports contain almost all activities on the site and are accurate and reliable as being prepared by public officials.

In order to more comprehensively understand how the construction is progressing, the contents of a specific activity dispersed by date are gathered in one place from the daily job-site work report and created by date. The contents are the position of the activity, the contents of the activity, the number of workers, the progress rate, and the like.

The risk evaluation is carried out by comprehensively determining contents analyzed from the daily job-site work report by the control unit and how dangerous the environment surrounding the activity set in a safety standard setting step.

### Advantageous Effects

According to the present invention, the following effects can be expected.

In the prior art, the risk was evaluated only for a high risk or major activity, but according to the present invention, the risk can be evaluated for almost all activities on the construction site and the industrial site. A full investigation of all activities can be performed.

In addition to the existing safety management activities, it is possible to analyze risks systematically and immediately by simply preparing the daily job-site work report that has been done in the past without inputting additional manpower, effort, time, policy, and system.

In the past, the risk evaluation was strongly subjective in that the content differed depending on the individual evaluator's competency. However, according to the present invention, since objective and systematic safety standards such as opinions of expert groups, laws, regulations, safety standards, and cases are prepared in advance, the risk evaluation is refined.

In the past, the daily job-site work report was used for the purpose of grasping the status of the activity or leaving a record. However, according to the present invention, it is possible to comprehensively grasp the status information of the site by using the lowest-level activity contents and personnel and equipment information of the daily job-site work report.

In the prior art, the start, the completion, and the progress status was managed mainly for some major activities, but according to the present invention, it is possible to generate a construction record by date for all activities on the site.

In the prior art, the daily job-site work report was prepared by date, and in order to know the preparation, the start, and the completion of a specific activity, it was necessary to read and organize the contents of the specific activity by date. However, it was difficult to comprehensively organize the contents because the contents were vast and cost a lot of manpower, time, and effort.

According to the present invention, since the control unit reads and comprehensively synthesizes the activity contents by date, the activity information is quickly and accurately synthesized in time series.

It is possible to know how many persons work on a specific floor, position, or space, and how dangerous the space is. Therefore, it is possible to minimize the disasters through intensive management because the worker can know many dangerous spaces in order.

In the past, it was difficult to analyze the preceding activity or the subsequent activity that made the specific activity dangerous, and even in a case of being analyzed, it took a lot of time and effort by the analyst manually analyzing it, and the content was also very subjective.

According to the present invention, it is possible to accurately grasp how the preceding activity or the subsequent activity related to the specific activity will affect the current activity status. Accordingly, it is possible to systematically analyze not only the problem of the specific activity itself, but also a relationship with the external environment (different activity type, preceding activity, subsequent activity, upper, lower, left and right activities) surrounding the specific activity.

The present invention thoroughly investigates the activity in progress on the site. By synthesizing the dispersed and fragmented information, the daily information about the activity is completed. Since the history of all activities can be known, a comprehensive determination becomes possible. How dangerous the current state of the activity is quantitatively analyzed by performing comparison with objective standards.

By identifying the status of the preceding activity and the subsequent activity related to the activity, how much the activity is currently affected is comprehensively evaluated. Such a process can be quickly and accurately collected, organized, synthesized, and evaluated in real time according to pre-prepared procedures and criteria to manage risk for all activities on the site.

As a result, it is possible to continuously eliminate problems that cause safety accidents and disasters.

### BRIEF DESCRIPTION OF THE DRAWINGS

FIG. 1 is a functional block diagram illustrating a configuration of a safety information server provided by generating safety information by using a daily job-site work report according to the present invention and a terminal.

FIG. 2 is a configuration diagram of a safety information generation apparatus using the daily job-site work report according to the present invention.

FIG. 3 is an additional functional configuration diagram of a safety standard database according to the present invention.

FIG. 4 is a conventional daily job-site work report format.

FIG. 5 is a flowchart of a safety information business process between a construction company, which generates and provides safety information using the daily job-site work report according to the present invention, and a partner company.

FIG. 6 is an example of setting safety standards for a specific activity according to the present invention.

FIG. 7 is an example illustrating a daily job-site work report prepared by a partner company performing an insulation activity according to the present invention.

FIG. 8 is an example illustrating a daily job-site work report prepared by the partner company performing a fire resistant coating activity according to the present invention.

FIG. 9 is an example illustrating a daily job-site work report prepared by a partner company performing a fire extinguishing piping activity according to the present invention.

FIG. 10 is an example of outputting respective daily job-site work reports collected in one place.

FIG. 11 is an example in which contents of a daily job-site work report prepared by a partner company performing an insulation activity according to the present invention are arranged by date for a specific activity.

FIG. 12 is an example in which contents of a daily job-site work report prepared by a partner company performing a fire resistant coating activity according to the present invention are arranged by date for a specific work.

FIG. 13 is an example illustrating results of a risk evaluation from FIGS. 11 and 12.

### BEST MODE FOR INVENTION

Hereinafter, an apparatus and method for safety information generation using a daily job-site work report according to the present invention will be described in detail.

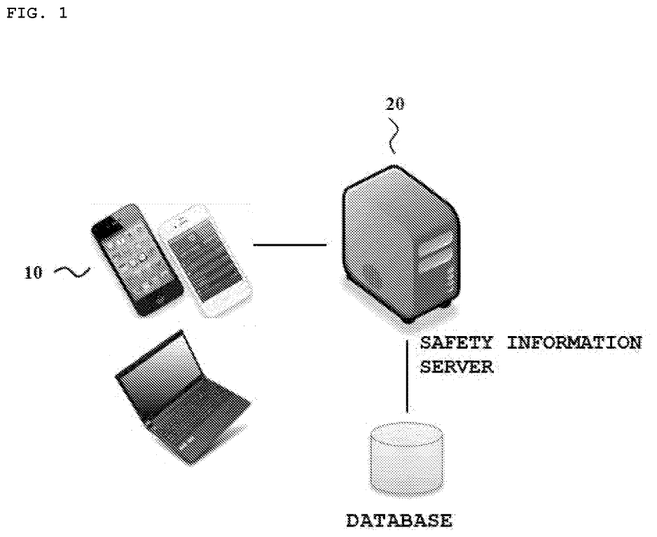

FIG. 1 is a block diagram illustrating a configuration of a safety information server 20 that generates and provides safety information using the daily job-site work report according to an embodiment of the present invention and a terminal 10.

Referring to FIG. 1, the safety information server 20 using the daily job-site work report according to the present embodiment is responsible for receiving and determining safety information, and providing the safety information to the terminal 10. The terminal 10 is responsible for inputting and inquiring the daily job-site work report or the safety information.

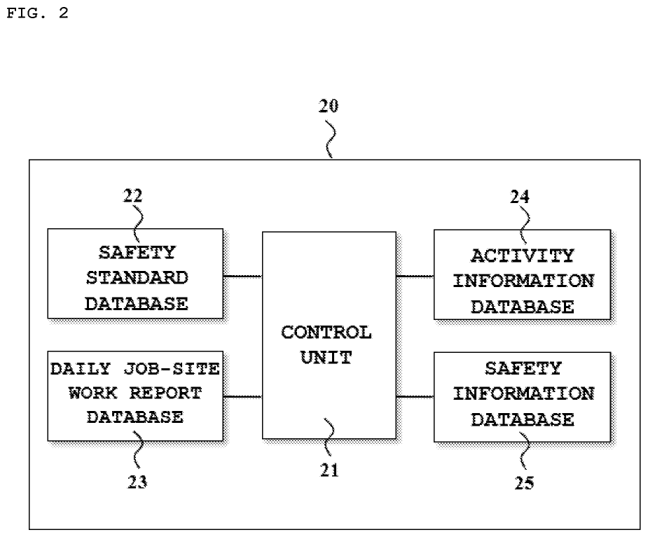

FIG. 2 illustrates a configuration of a safety information generation apparatus using the daily job-site work report according to an embodiment of the present invention.

Referring to FIG. 2, the functional configuration of the safety information server 20 according to the present embodiment includes a control unit 21, a safety standard database 22, a daily job-site work report database 23, an activity information database 24, and a safety information database 25.

The control unit 21 stores a safety-related standard in the safety standard database 22 and stores daily job-site work report in the daily job-site work report database 23. In addition, after reading activity contents from the daily job-site work report database 23 and generating the activity contents by date of the specific activity, the activity contents are stored in the activity report database 24. In addition, the control unit 21 is responsible for transmitting the contents of the database to the terminal 10 according to the user's request.

The control unit 21 may display a degree of risk for each step, level, and grade for the activity exceeding the safety standard. It may display the size and influence of the disaster expected on the site by being sorted in order of magnitude.

The control unit 21 may inquire of the creator of the daily job-site work report when the contents of the daily job-site work report do not match or there is a risk of a safety disaster. The control unit 21 may display the activities of a plurality of companies to be constructed in a specific space in the form of text, company-specific, and activity icon on a drawing plane or 3D space. The control unit 21 reads and displays countermeasures from a countermeasure database for the activity exceeding the safety standards.

The safety standard database 22 stores safety standards for a specific activity. For example, the activity name is cleaning a septic tank, and the safety standards and rules are measuring the concentration of oxygen and harmful gas, performing ventilation, and wearing an air respirator or oxygen mask.

When the concentration of hydrogen sulfide reaches 20 to 30 ppm, the olfactory nerve cells become fatigued, and when it exceeds 700 ppm, the oxidative capacity in the blood is exceeded and neurotoxic action occurs by attacking the nerve cells.

The safety standard database 22 also stores conditions of the preceding activity or conditions of the subsequent activity for the specific activity. For example, it is important whether the valve is closed in the preceding activity in the activity of the specific equipment activity type. This is a case where the valve is temporarily opened and is not closed, an explosion or pipe bursting may occurs when performing the subsequent activity type.

As conditions for the subsequent activity, in a case where the specific activity is to spray a material with high fire risk as an insulation material, the fire resistance material coating activity surrounding the painting material must be followed. If the subsequent activity is not undertaken or followed late, the insulation material painting is greatly exposed, thereby increasing the fire risk. A difference between spraying the insulation material that is the current activity and the fire resistance material painting that is the subsequent activity, or a difference in the progress rate is set. Since such a difference may vary depending on the number of floors, an area, or the like, it is preferable to set the range in consideration of the site characteristics.

The safety standard database 22 is prepared for each activity type. Each activity type includes civil engineering, construction, electricity, equipment, environment, plant, and the like, and a name and code are assigned according to the activity breakdown structure. For example, the name of excavation is excavation, the code is 110, and the code of the reinforced concrete construction is 301, and it is classified into stages such as the code of the reinforcement construction is 301-01, the code of the formwork is 301-02, and the code of the concrete construction is 301-03, which are the lower levels.

The activity name may be written and saved in the language of each country, such as Korean, English, Japanese, Chinese, Indian, or Spanish.

In addition, the safety standards are stored on the server of the construction company's headquarter. The safety standards can be downloaded from the safety standard database server of the construction company headquarter to the server of each site to be used. The manager of the construction company or each specialized construction company can modify and use the safety standards according to the characteristics of the site, and create and use new standards.

The safety standard database 22 may also include objective standards of specifications and laws, and include disasters and accident examples. Past safety disasters are classified by including information such as the construction pattern and the activity types (construction, electricity, and the like) so that they can be matched with on-site activity.

The safety standard database 23 can be shared by being supplied to national institutions, research institutes, other construction companies, and even other countries after being stored on the server by a specific construction company.

The daily job-site work report database 23 stores the daily job-site work reports prepared by the partner companies for each type of work, such as temporary installation, civil engineering, construction, electricity, or equipment. The daily job-site work report is prepared on the web page of the Excel file, the Korean file, the word file, and PMIS. The activity place of the daily job-site work report can be entered by selecting it from the plane of the drawing, 3D modeling of BIM, and the place list. In the daily job-site work report, divisional input of activity hours (am and pm), change, cancellation, start, and completion of the activity can be entered. When the activity contents are changed, the control unit 21 analyzes the safety influence due to the change again. The daily job-site work report is entered by using an app on a PC or smartphone.

The activity information database 24 stores the information that the control unit 21 reads the activity contents for a specific activity by date from the daily job-site work report database 23 and arranged in a time series. For example, the spraying insulation activity, which is a material that is easy to catch fire on the fourth basement floor, is called an activity A. In the daily job-site work report, it is assumed that the description is as follows: the activity A preparation on October 1, start of the activity A on October 2 (3 workers), the activity A in progress on October 3 (in progress 20%, 4 persons), the activity A in progress on October 4 (in progress 50%, 5 persons), and the activity A in progress (75%, 5 persons) on October 5.

The control unit 21 reads the daily job-site work report, organizes when the activity A started and what the current progress is, collects and generates comprehensive activity information in one place, and then systematically stores it in the activity information database 24.

In a state in which the daily job-site work report describes many activities by date in a list format, information about a specific activity is extracted and collected in one place to generate when and how the activity starts.

The safety information database 25 stores risk evaluation information analyzed by the control unit 21. For example, the control unit 21 determines from the activity information database 24 that the activity A is spraying insulation material on the ceiling of the fourth basement floor and spraying 75% of the total area at the current time of evaluation. In addition, the control unit 21 reads from the safety standard database 22 whether there is a preceding activity condition or a subsequent activity condition. As the subsequent activity condition, the fire resistance material painting activity (activity B) must be started within 2 days from the start date of the activity A.

Alternatively, if the difference between the progress rates of the activity A and the activity B exceeds 30%, the fire risk is determined to be medium, and if it exceeds 60%, the fire risk is determined to be very high. In addition, if it is determined whether there is electric welding or a gas welding activity on the same floor or room, it is evaluated that the fire risk is high. The analysis result as described above is stored in the safety information database 25.

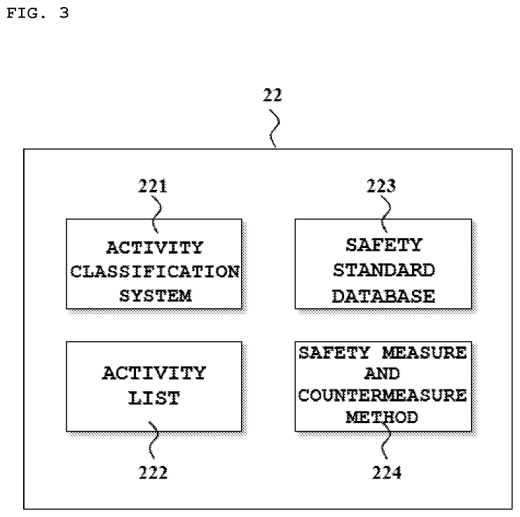

FIG. 3 illustrates an additional functional configuration of the safety standard database 22 according to an embodiment of the present invention.

Referring to FIG. 3, information on an activity classification system 221, an activity list 222, a safety standard 223, and a safety measure and countermeasure method 224 of the safety standard database 22 according to the present embodiment is stored.

The activity classification system 221 is an activity breakdown structure (work breakdown structure (WBS)) in which temporary installation construction, civil engineering construction, building construction, electrical construction, facility construction, and the like are classified as a large-scale construction type, a middle-scale construction type, and a small-scale construction type. This WBS has a code and a name, and has been previously written and used in the industry. However, depending on the construction, some items may be missing or added. Hotel construction, office construction, apartment construction, factory, and the like may have different construction types in the activity classification system.

The activity list 222 is a list in which the activity is divided by floor, room, and line based on the activity classification system 221. Since the RC construction is carried out by floor unit, it is divided by floor and zone, such as the fifth basement floor and the fourth basement floor to the 50th floor, from the reinforced concrete construction 303 classification system.

In addition, the activity list is configured of detailed activities (tasks) below. The 10th floor RC construction is configured of column reinforcement, column frame, slab formwork, slab reinforced, concrete, electricity, and installation activities.

The safety standard 223 stores the safety standard of the specific activity. It stores contents about the safety standards of the relevant activity itself, and the standards for the preceding activity, the subsequent activity, and up, down, left, and right spatial activities.

The safety measure and countermeasure method 224 store information such as how to take countermeasures when the risk of the specific activity is evaluated, related regulations, quantitative figures, and other site cases. This information is used by users to quickly and accurately establish professional solutions.

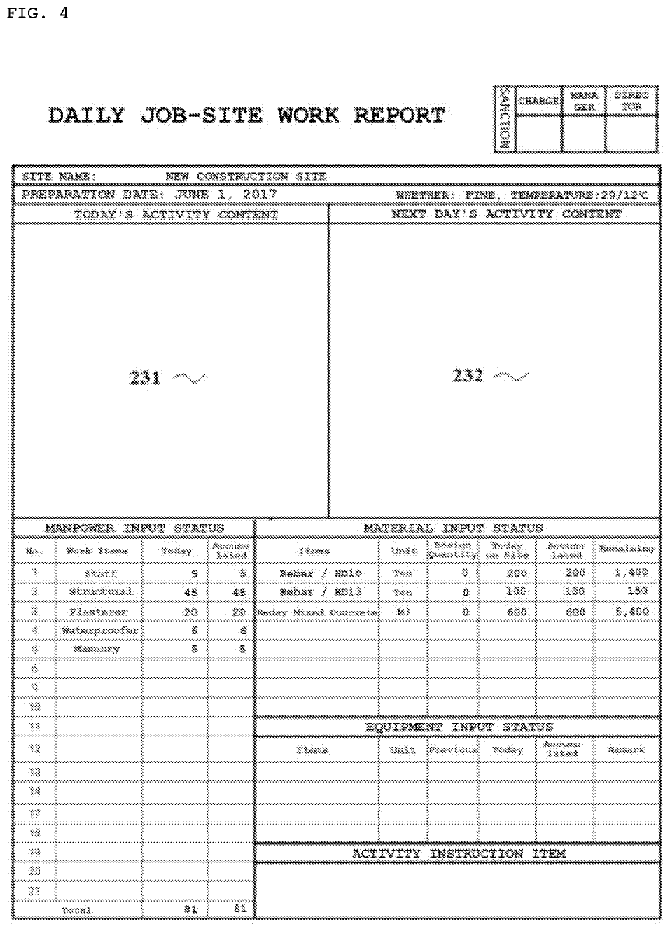

FIG. 4 is a conventional work report form. FIG. 4 is an Excel file, and the activity contents are described in the today's activity content 231 column and next day's activity is described in the next day's activity content 232 column. Since the activity is usually carried out for several days, after writing the activity for today, copy and paste it into the activity for next day, and then make some modifications.

The daily job-site work report is prepared by each partner company, and a number of partner companies participate, such as waterproofing, painting, scaffolding, elevator installation, and fire extinguishing piping. In the case of using PMIS using the Internet, the activity contents are described in the same way in the today's activity content 231 column and the next day's activity content (232) column.

The number of persons and progress rate can be indicated in parentheses after the activity name. In this case, the activity information of the relevant activity job can be clearly grasped.

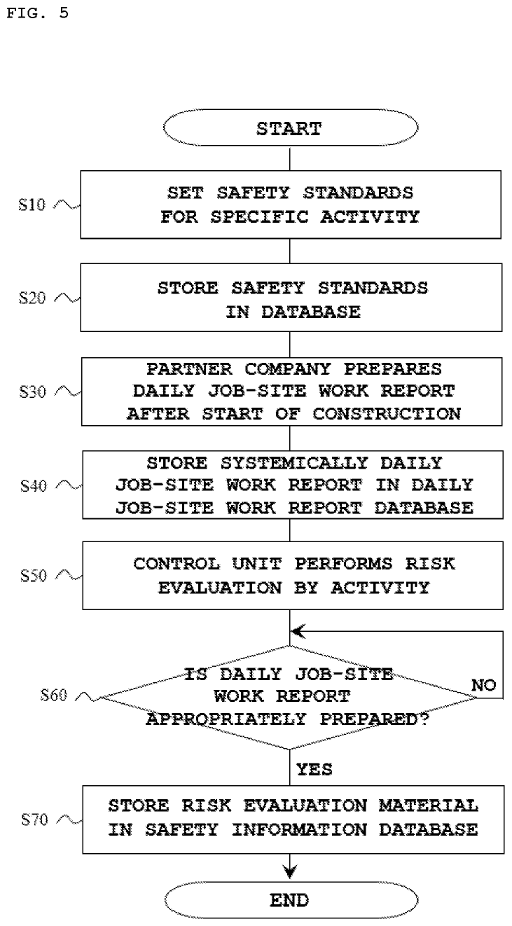

FIG. 5 is a flowchart illustrating a safety information business process between a construction company and a partner company for providing by generating safety information using the daily job-site work report according to each embodiment of the present invention.

First, referring to FIG. 5 according to an embodiment, the construction company and the partner company prepare safety standards for the specific activity (S10).

For example, the safety standards and rules for cleaning the septic tank include measuring the concentration of oxygen and harmful gas, performing ventilation, and wearing an air respirator or an oxygen mask.

In a case of electrical equipment, the order of the activity is established and the condition is set in which the subsequent activity should not be started if the preceding activity is not completed or the current status is in any situation. In a case of electrical room construction, the standard is that no activity can be performed while electricity is on.

In a case of construction, the condition is that the activity cannot be started unless safety facilities are identified.

When the safety standards are prepared, they are systematically stored in the safety standard database 22 (S20). Here, The safety standards are saved by using an activity breakdown system (activity Breakdown system) suitable for on-site construction characteristics, or the conventional construction type codes of civil engineering, construction, electricity, and equipment can be used.

In order to prepare the daily job-site work report more quickly and accurately, it includes a method of unifying the activity names, preparing a list in advance, and then selecting and inputting the list. For example, in the case of waterproofing construction, the floor and room (toilet, and the like) to be worked can be known, so the activity list is prepared in advance and select it when inputting in the daily job-site work report, the activity name and activity position are automatically input and standardized.

Now, when the construction starts, the partner company prepares the daily job-site work report (S30). For example, when the vertical plumbing of the machine room on the sixth basement floor is started in facility construction, the activity contents are prepared as a today activity in the daily job-site work report and also describes a today planed activity. Personnel or equipment safety-related items may also be included.

Since the daily job-site work report has been well-known for a long time, a detailed explanation will be omitted.

On the other hand, among the many partner companies, there are partner companies who do not have temporary offices or PCs as a small number of persons print the activity contents. In this case, it can be transmitted to the stability information server 20 by describing the activity contents with a smartphone. When using the smart phone, it is possible to quickly and accurately input the activity name by selecting the activity list prepared in the standard setting steps (S10 to S20).

When the daily job-site work reports of the partner companies are completed, the daily job-site work reports are now created and stored (S40). Activity information is generated in the time series for the activities that the partner company is working on. For example, the control unit 21 reads the activity report of the partner company in charge of waterproofing, generates a construction record by date from the start date of the toilet waterproofing construction on the fourth basement floor, and systematically stores it in the activity information database 24. The contents are the start date, the progress rate, the number of workers on the construction of the toilet on the fourth basement floor, and may additionally include information on construction materials and activity equipment.

When the daily job-site work report is prepared, the risk evaluation is performed in the next step (S50). The control unit 21 reads the activity information from the activity information database 24. In addition, the safety standards related to the specific activity are read from the safety standard database 22. Then, the activity information and the safety standards are compared. As a result of comparison, it is quantitatively determined that there is a risk if the safety standards are exceeded.

The determination result is systematically stored in the safety information database 24.

For example, if there is the welding activity in a space where the insulation material spraying is performed, the control unit determines that the insulation material spraying is not safe because the insulation material spraying can cause a fire. In addition, by comparing the start date or the progress rate of the insulation material spraying with the progress rate of the fire resistance material painting activity, which is a subsequent activity condition, it is evaluated that there is a risk if it deviates from the standards.

In a case of equipment, if there is a pipe barometric pressure test for a specific line today, check is performed whether water vapor was discharged the previous day. If water vapor in the pipe is not discharged, it is determined that an explosion may occur during the barometric pressure test.

In a case of electricity, if there is electricity in the electrical room, a risk of electric shock occurs when the water-related activity starts, so the electricity must be cut off. In addition, it is determined whether there is any water-related activity in the upper floor of the electrical room, and whether water can enter the electrical room on the lower floor when water leak occurs.

In this way, the control unit 21 measures the preparation, facility, and equipment of the activity itself for performing the relevant activity with respect to the specific activity. In addition, it comprehensively determines the risks of the preceding activity and the subsequent activity conditions, the activity process, and all activities generated in the upper, lower, left, and right spaces surrounding the specific activity.

In addition, the control unit 21 comprehensively evaluates the mutual influence and risk between all activities for all activities on the site with reference to the standards set in the safety standard 22.

As a result of the determination of the control unit 21, if there is no necessary information in a case where the activity contents are omitted or difficult to read in the contents of the daily job-site work report, a query content is prepared. Therefore, when the manager of the partner company or the construction company confirms the contents and corrects the daily job-site work report 22 or the activity information 24, or writes an answer to the query, the control unit 21 performs the risk evaluation (S50) again with reference to the answer (S60).

Next, when the risk evaluation (S50 and S60) is completed, the control unit 21 stores the evaluation result in the safety information database 25 and outputs that the evaluation is completed to the terminal 10 (S70).

For example, a prime construction company who oversees all partner companies can view all safety information 24. The waterproofing partner company inquires about the risk evaluation of the waterproofing construction through a PC or smartphone.

Additionally, the control unit 21 may prepare countermeasure information such as a risk-related measuring method, a procedure book, law, regulation, and the like. The countermeasure information may be prepared in advance in the safety standard database 23 to be utilized.

After confirming the contents in the step of confirming the risk (S70), the construction company or the worker of the partner company takes necessary safety measures, and then inputs the result of the measures into the safety information database 25.

The control unit 21 may release the risk with respect to the risk evaluation for which the countermeasures have been completed, and modify the contents of the daily job-site work report 23 and the daily job-site work report 24. Alternatively, the creator of the daily job-site work report 23 may prepare the daily job-site work report by reflecting the safety information countermeasure result when preparing the daily job-site work report the next day.

### Modes for Carrying Out the Invention

The following illustrates embodiments of the specific activity of a construction site according to the present invention in FIGS. 5 to 13.

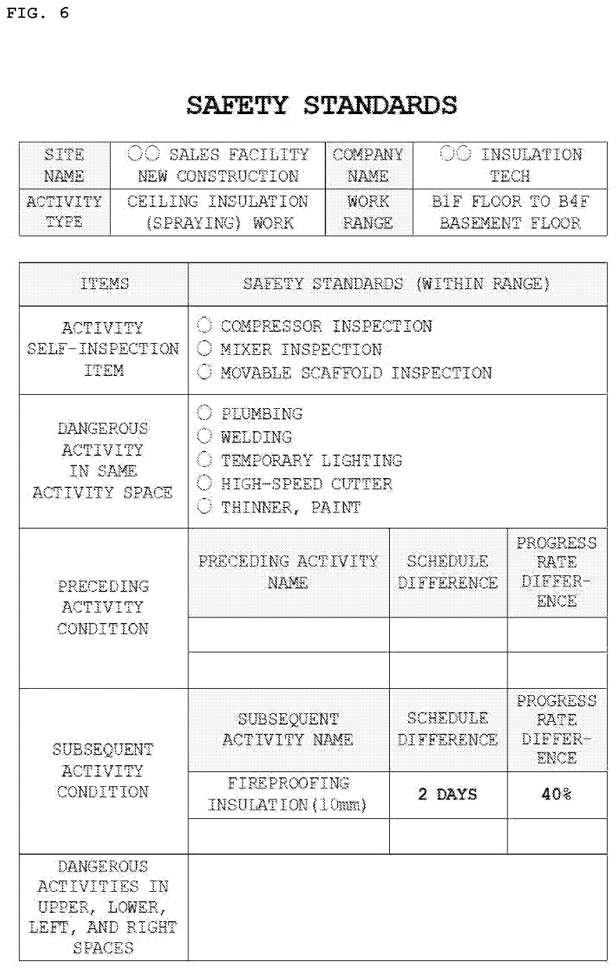

FIG. 6 is an example of setting safety standards for specific activity according to the present invention. Referring to FIG. 6, it is a process of constructing polyurethane foam on the ceiling for insulation of the basement floors, the floors are from the fourth basement floor to the first basement floor, and the partner company is oo company.

First, the first column illustrates the safety standard items newly proposed in the present invention. In the second column, the safety standards are established.

First of all, the activity self-inspection item that is the first item in the first column is the safety standard that the oo company must follows during the construction of polyurethane foam which is an insulation material. It is necessary to inspect the equipment and the temporary scaffold for the construction of polyurethane foam.

The second is a dangerous activity in the same activity space, and it establishes that it may not be safe by working with other construction types within the floor and space where polyurethane foam is constructed. For example, if the words or meanings of plumbing, welding, temporary lighting, high-speed cutter, thinner, or paint are carried out together in the same space by another partner company, a fire may occur.

This is because polyurethane foam sprayed on the ceiling is weak against fire and can burn, and it can cause serious disasters by spewing poisonous gas.

The third item is the preceding activity condition in which the preceding activity may be indicated for the construction of the current activity. For example, if the activity which is currently being performed is masonry for an exterior wall, an exterior scaffold must be installed.

The fourth item is the condition for the subsequent activity, which establishes what kind of state of the subsequent activity or relationship with the current activity should be for the construction of the current activity. As illustrated, since polyurethane foam is weak against fire, it is necessary to prevent a fire by spraying fire resistant coating on the polyurethane foam as a subsequent process after the polyurethane foam is constructed on the ceiling.

However, even though the polyurethane foam is constructed on the ceiling, if the fire resistant coating, which is a protective material, is not sprayed or the following speed is slow, the risk of fire due to flame increases. The schedule difference is the standard for how many days difference between the polyurethane foam and the fire resistant coating should be.

Since the range of the polyurethane foam spraying is not large for 1 to 2 days, damage is limited even in case of fire. However, if there is a difference of 3 days or more, or if two progress rates differ by more than 40%, the area of the polyurethane foam exposed from the fire resistant coating increases, thereby increasing the risk of fire and damage.

Since the difference in schedule and the difference in the progress rate described above are newly proposed according to the present invention, it is preferable that the standards are determined by those involved in the construction in consideration of the construction space and the area to be sprayed.

The fifth item is dangerous activities in the upper, lower, left, and right spaces and in which for the current activity, the type of activity that becomes a dangerous situation when being constructed next to the upper floor or lower floor is selected and described. For example, if water enters the electrical room on the lower floor by carrying out the activity that can cause falling disasters and water spilling due to upper and lower simultaneous activities, an electric shock accident may occur caused by high-voltage electricity.

As described above, the prior art is focused on an unsafe activity in the same space, but the present invention emphasizes the importance of the relationship between the preceding activity and the subsequent activity. This is because, in most cases, the process of completing a specific space and carrying out the finishing activity and the electrical installation activity is a serial relationship rather than a single activity, and these activities mutually influence each other.

The safety standard utilizes the conventional related laws and guidelines, but it is determined to be largely effective to introduce the concept of process management for additional safety accident prevention, analyze the influence between some activities in the time series, and limit the range of the influence to be set as the safety standard.

Comprehensively, the status of all activities on the site is grasped every day as much as possible at the lowest level through the daily job-site work report, and if the safety management standards are exceeded, the risk of safety accidents increases. Knowing the problem is of the utmost importance, and solutions can be established and acted upon with current technology.

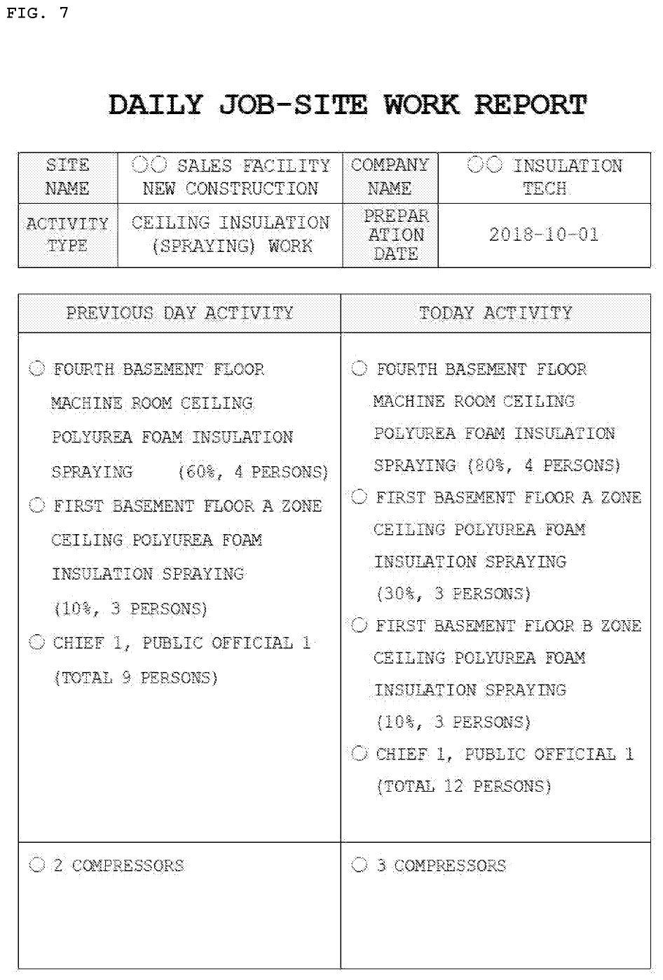

As a next step, FIGS. 7 to 9 illustrate a daily job-site work report preparing step.

First, FIG. 7 is an example illustrating a daily job-site work report prepared by a partner company performing the insulation activity according to the present invention. It is similar to the conventional daily job-site work report, and it can be prepared quickly and easily on the web of Korean file, MS Word Excel or PMIS, and by using a smartphone.

In the previous day activity column, it is briefly described how many persons did which work, in which area, on which floor, and to what extent.

In the today activity column, following yesterday, it illustrates that the activity of spraying polyurea foam on the ceiling is in progress in the machine room on the fourth basement floor and in Zone A on the first basement floor, and the activity starts in Zone B on the first basement floor on today.

The partner company may only simply describe where and what kind of activity the workers of his/her company are doing.

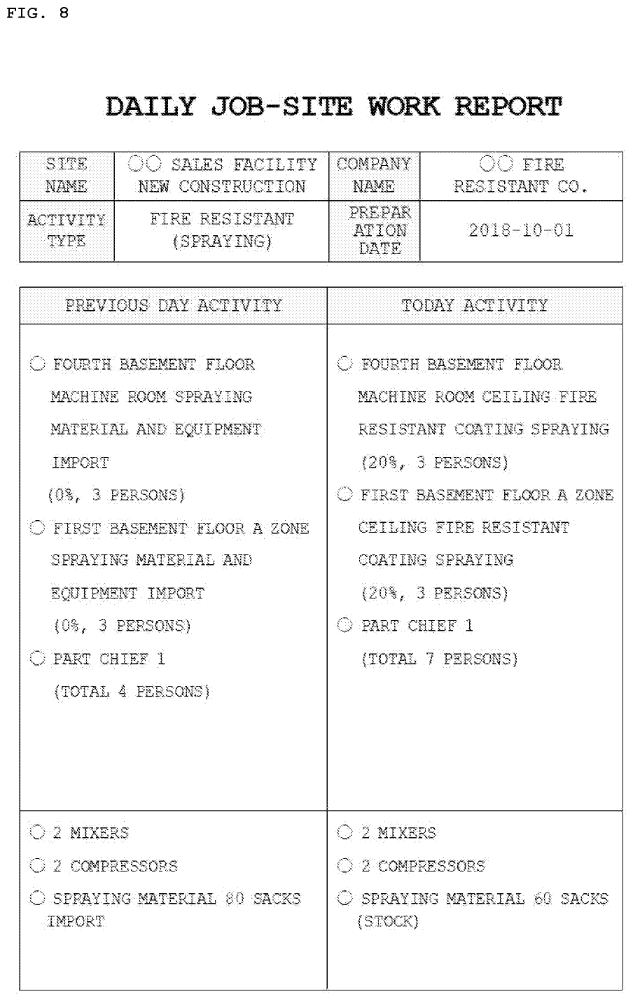

FIG. 8 is an example illustrating a daily job-site work report prepared by a partner company performing the fire resistant coating activity according to the present invention. When the spraying of the polyurea foam of FIG. 7 is performed, the activity of spraying the fire resistant coating of FIG. 8 on the polyurea foam follows. FIG. 7 is the current activity and FIG. 8 is the subsequent activity. As the distance between FIGS. 7 and 8 increases, the risk of fire increases.

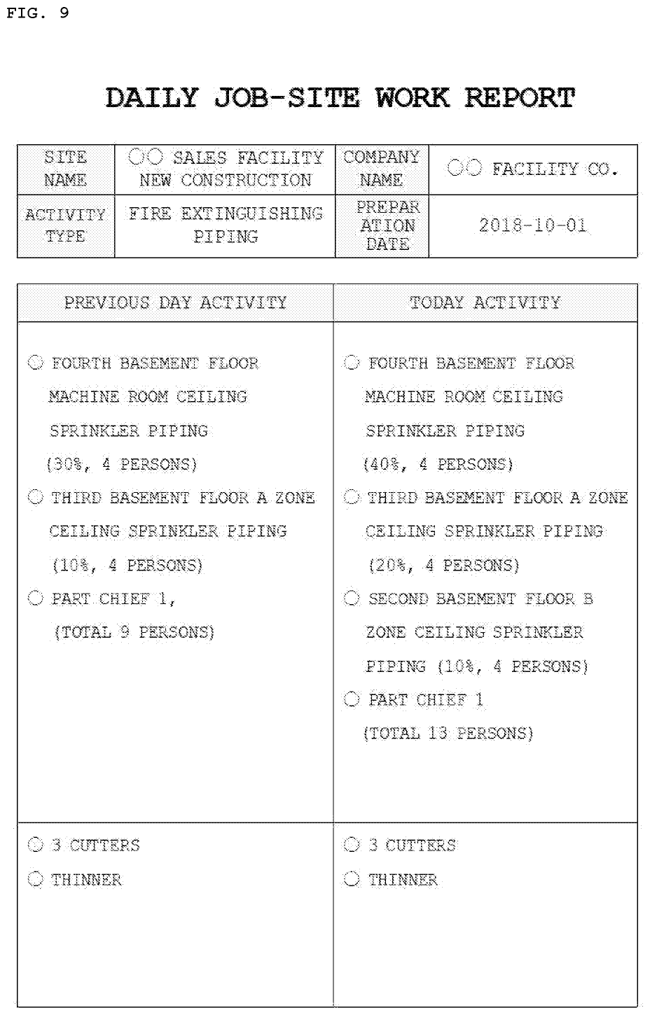

FIG. 9 is an example illustrating a daily job-site work report prepared by a partner company performing the fire extinguishing piping activity according to the present invention. It describes that the activity is in progress in the machine room on the fourth basement floor.

FIGS. 7, 8, and 9 illustrate examples of the daily job-site work report related to the machine room on the fourth basement floor among the daily job-site work reports prepared by a number of partner companies as described above. The partner companies may describe to the activities that their own companies are doing as illustrated in FIGS. 7 to 9.

Since the daily job-site work report describes the daily activity contents, it is not limited to the above form, and the risk evaluation memo pad and other construction data can also be used as the daily job-site work report if the activity name and position activity date information are included.

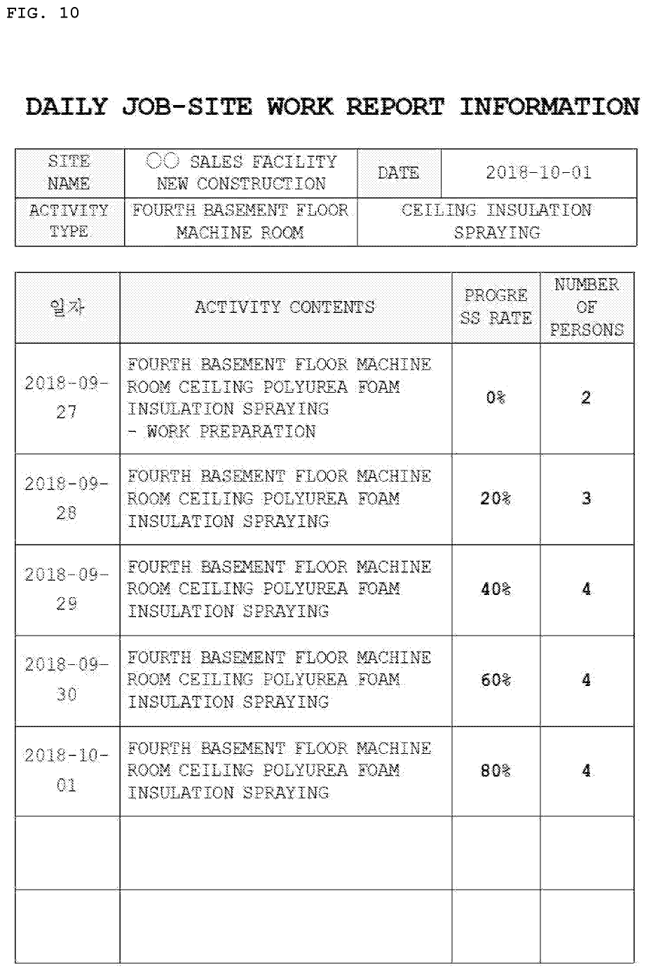

When each partner company prepares the daily job-site work report, the number of pages is large, so it is necessary for the original construction company to collect them in one place. FIG. 10 is an example in which respective daily job-site work reports on Oct. 1, 2018 are collected at one place. In FIG. 10, the daily job-site work reports prepared in FIGS. 7, 8, and 9 are integrated and displayed. The control unit 21 performs such an activity.

In a case of the large-scale construction during the fining construction period, more than a dozen partner companies work and write the daily job-site work reports, so the number of pages in FIG. 10 is large and the content is vast.

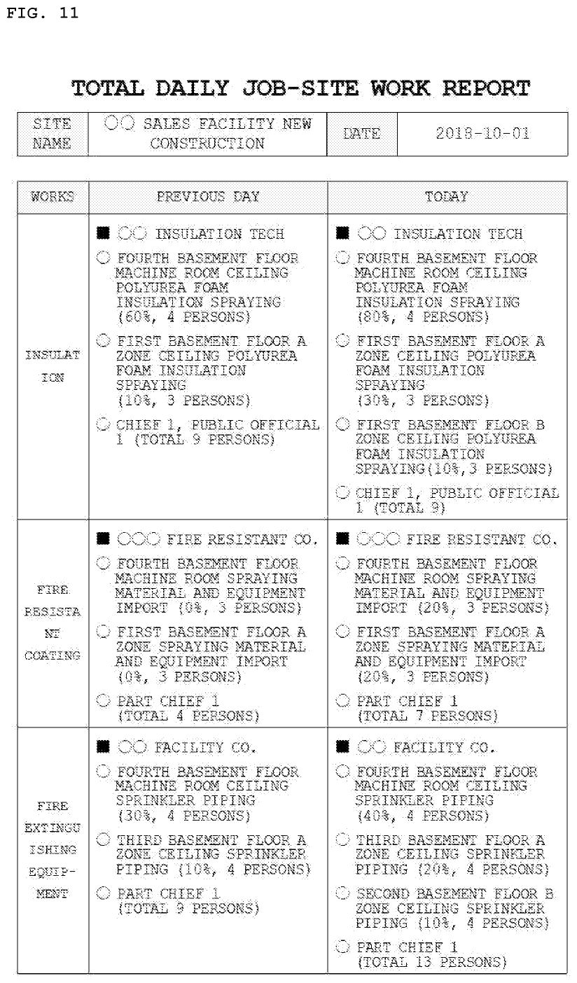

FIG. 11 is an example in which the contents of the daily job-site work report prepared by a partner company performing insulation activity according to the present invention are arranged by date with respect to a specific activity.

Polyurea foam spraying for the insulation of the ceiling of the machine room on the fourth basement floor started on September 27th and is working on the fifth day today. The progress rate is 80% and will be completed tomorrow.

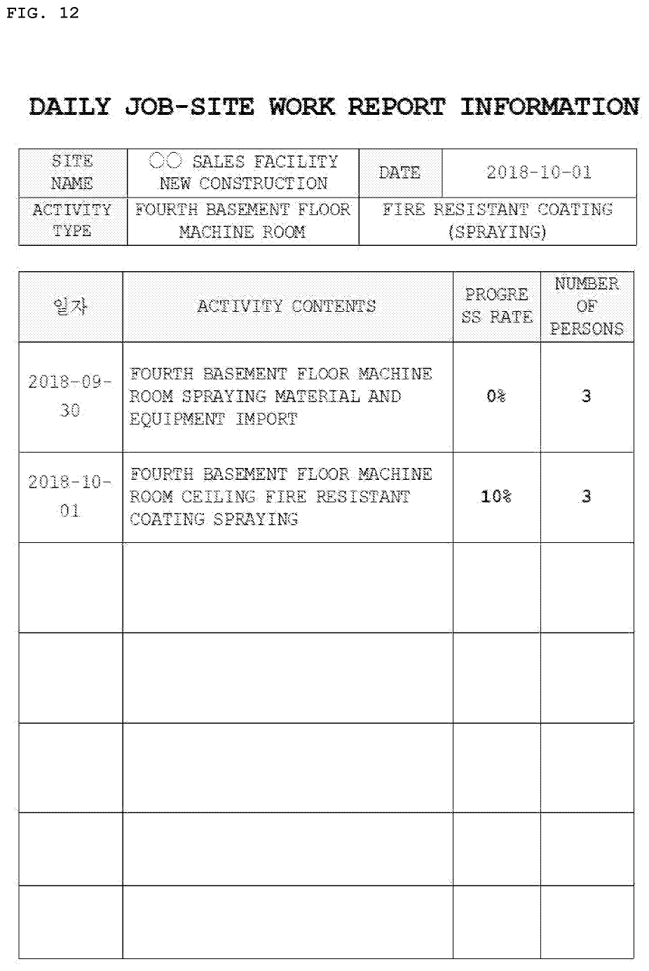

FIG. 12 is an example in which the contents of a daily job-site work report prepared by a partner company performing a fire resistant coating activity according to the present invention are arranged by date for a specific work.

In order to protect the polyurea foam spray of FIG. 11 constructed on the ceiling of the machine room on the fourth basement floor, fire resistant coating is being constructed as the subsequent activity. The activity was prepared on September 30th, and the activity started on October first today.

FIGS. 11 and 12 are automatically prepared from the daily job-site work reports of FIGS. 7 and 8. FIGS. 7 and 8 have a disadvantage in that the flow can be known by looking at the contents of the machine room on the fourth basement floor every day. Referring to FIG. 11, it is possible to know the activity of FIG. 7 by date without looking at it every day.

FIGS. 11 and 12 are used to determine whether the safety standard of FIG. 6 is exceeded by calculating the difference in the start date or the difference in the progress rate between the preceding activity and the subsequent activity.

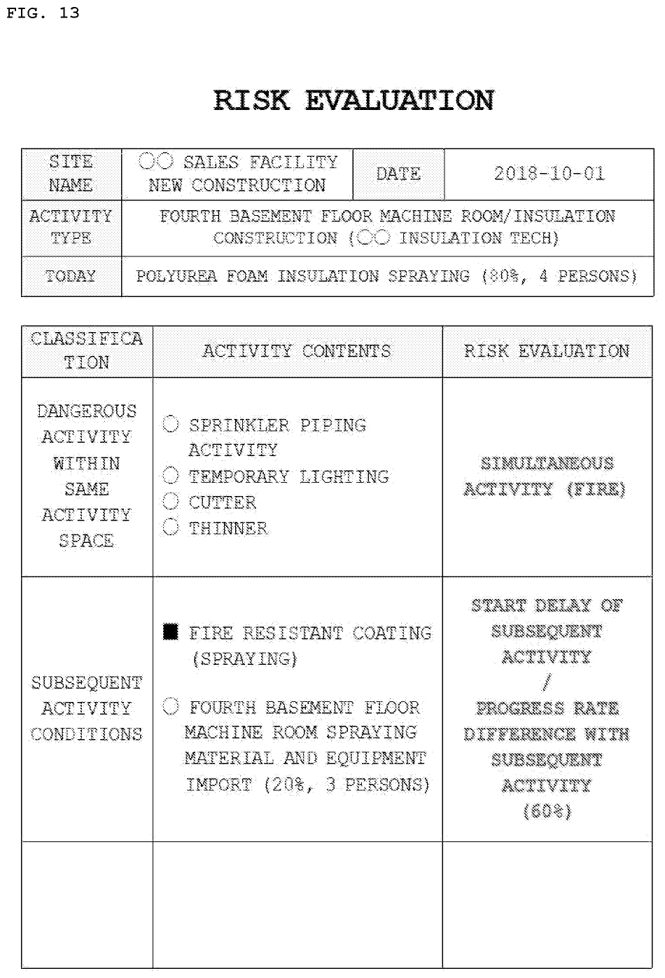

FIG. 13 is an example illustrating results of risk evaluation from FIGS. 11 and 12. In FIG. 11, polyurea foam spraying is started on September 27 and the activity is being completed, but the fire resistant coating construction of FIG. 12 for fire prevention is started late on October 1, thereby leaving the polyurea foam exposed to fire.

The control unit 21 determines whether the difference in schedule of FIGS. 11 and 12, and the difference in progress rate exceeds the subsequent activity condition and displays the result. According to the evaluation contents, as of October 1, almost all of the polyurea foam spraying is performed at 80% on the ceiling of the machine room on the fourth basement floor, and on the indoor bottom of the same floor, the activity for cutting the pipe with a high-speed cutter and the activity for cleaning the pipe connecting parts with a thinner are performed for the installation activity of the facility sprinkler fire extinguishing pipe. In addition, the fire resistant coating construction is about to start now.

If the pipe is cut with the cutter, sparks fly, and the sparks stick to the thinner, it catches fire, and if the fire moves to the ceiling, most of the polyurea foam catches fire. This is because the subsequent process, that is, fire resistant coating spraying follows later.

Currently, the machine room is evaluated to have a very high risk of fire as several activities are being performed. In the past, polyurea foam ignited in the basement and serious disasters caused by smoke have been reported in the news several times.

Although the cause of the accident is generally focused on the management of the cutter and the flame of the thinner, when looking at the examples of the assumption according to the present invention, if the cause of the accident is analyzed three-dimensionally in a time series not only for other activities in the space, but also the statuses of additional upper and lower activities, and the preceding and subsequent processes, the fire resistant coating that is the subsequent process is started late and followed later, and thereby it is also the cause of the failure to protect the polyurea foam from the flame through the fire resistant coating. If it was pointed out in advance that the start of the fire resistant coating would be delayed through the application of the present invention, the fire would not have occurred or the damage would not been large through the measures.

### Industrial Applicability

According to the present invention, it can be applied to various activities (civil engineering, construction, electricity, equipment, environment, plant) processing in all spaces on construction and various industrial sites (shipbuilding, automobiles, and the like). When professional construction companies input activities to be performed by themselves, using PCs or smartphones, the control unit according to the present invention can comprehensively identify the activity environment of the activity place, the precedence relationship between activities, safety standards, and the like in real time, analyze the high-risk activity and perform notification thereof. Therefore, it is possible to be used as a method of reducing safety accidents.

1. A safety information generation apparatus using a daily job-site work report in a risk evaluation using a daily job-site work report to prevent disaster on an industrial site, the apparatus comprising:
a safety standard database that sets and stores a safety standard for an activity;
a daily job-site work report database that stores contents of the daily job-site work report; and
a control unit that determines a risk of the activity by reading the daily job-site work report and comparing the daily job-site work report with the safety standard.

2. The safety information generation apparatus using a daily job-site work report according to claim 1, further comprising:
a daily job-site work report database that generates and stores the contents of the activity in a time series using the daily job-site work report; or
a safety information database that evaluates and stores a risk of the activity through comparing the daily job-site work report with the safety standard.

3. The safety information generation apparatus using a daily job-site work report according to claim 1, wherein the safety standard includes at least one of an installation status of safety facilities that the activity must have, environmental statuses of gas, temperature, humidity, and water, an activity order, a procedural status, conditions (start, completion, schedule difference, and progress rate) that the precedent activity must have, and conditions (start, schedule difference, and progress rate) that the subsequent activity must have.

4. The safety information generation apparatus using a daily job-site work report according to claim 1,
wherein the safety standard sets a relationship with a parallel activity, a preceding activity, and a subsequent activity for a specific task;
wherein the relationship includes a standard related to at least one of start, completion, schedule difference, and progress rate difference.

5. The safety information generation apparatus using a daily job-site work report according to claim 1, wherein the safety standard further includes at least one of an activity classification system, an activity list in which activities are divided by floor, room, and system based on the activity classification system, a safety measure, and a countermeasuring method.

6. The safety information generation apparatus using a daily job-site work report according to claim 1, wherein the daily job-site work report includes schedule information on an activity name, an activity position, an activity start time, or an activity completion time.

7. The safety information generation apparatus using a daily job-site work report according to claim 1, wherein the daily job-site work report is prepared by using a spreadsheet (Excel), a word processor (Korean word process and Word), text inputter, mobile (smartphone), and PMIS.

8. The safety information generation apparatus using a daily job-site work report according to claim 1, wherein the control unit reads the daily job-site work report of the partner company and compares the relevant activity with conditions of the activity itself set in the safety standard, compares the relevant activity with the preceding activity condition, compares the relevant activity with the subsequent activity condition, or compares the relevant activity with the activity type that should not be performed at the same time in the activity space, or compares the relevant activity with at least one of the conditions of other activities in the upper, lower, left, and right spaces to be determined as a risk.

9. The safety information generation apparatus using a daily job-site work report according to claim 1, wherein the control unit evaluates the risk by comparing at least one of the start, the completion, the schedule difference, and the progress rate difference between a parallel activity, a preceding activity, and a subsequent activity for a specific activity.

10. A safety information generation method using a daily job-site work report in a risk evaluation method using a daily job-site work report to prevent disaster at an industrial site, the method comprising:
a step of setting a safety standard for an activity and storing the safety standard in a safety standard database;
a step of preparing the daily job-site work report and storing the daily job-site work report in a daily job-site work report database; and
a step of evaluating a risk by reading the daily job-site work report and determining whether the activity contents exceeds the safety standard by a control unit.

11. The safety information generation method using a daily job-site work report according to claim 10, further comprising:
a step of generating activity contents in a time series using the daily job-site work report and storing the activity contents in the daily job-site work report database; and
a step of evaluating the risk of the activity through comparison between the daily job-site work report and the safety standards and storing the evaluation in the safety information database.

12. The safety information generation method using a daily job-site work report according to claim 10, further comprising:
a step of describing at least one of an installation status of safety facilities that the activity must have, environmental statuses of gas, temperature, humidity, and water, an activity order, a procedural status, conditions (start, completion, schedule difference, and progress rate) that the precedent activity must have, and conditions (start, schedule difference, and progress rate) that the subsequent activity must have in the safety standard.

13. The safety information generation method using a daily job-site work report according to claim 10, further comprising:
a step of further describing at least one of an activity classification system, an activity list in which the activity is divided by floor, room, and system line based on the activity classification system, a safety measure, and a countermeasuring method in the safety standard.

14. The safety information generation method using a daily job-site work report according to claim 10, further comprising:
a step of describing the activity name, the activity position, and the activity contents in a form of a combination of words or a narrative

15. The safety information generation method using a daily job-site work report according to claim 10, further comprising:
a step of determining a risk by reading a daily job-site work report of a partner company by date and performing by a control unit at least one of a comparison with the conditions of the activity itself set in the safety standards for the relevant activity, a comparison with a preceding activity condition, a comparison with a subsequent activity condition, a comparison with an activity type that should not be performed at the same time in an activity space, and a comparison with at least one of conditions of the activities performed in upper, lower, left, and right spaces.

16. The safety information generation apparatus using a daily job-site work report according to claim 10, further comprising:
a step of evaluating a risk by determining one of a start, a completion, a schedule difference, and a progress rate difference between a parallel activity, a preceding activity, and a subsequent activity based on a risk evaluation target activity by a control unit.

17. A computer-readable recording medium on which the safety information generation method using a daily job-site work report according to claim 10 is recorded.
